(19) United States
(12) Patent Application Publication
(10) Pub. No.: US 2005/0223110 A1
(43) Pub. Date: Oct. 6, 2005

(54) Heterogeneous building block scalability

(75) Inventors: Hooman Honary, Newport Coast, CA (US); Anthony L. Chun, Los Altos, CA (US); Inching Chen, Portland, OR (US)

Correspondence Address: LeMoine Patent Services, PLLC;c/o PortfolioIP, P.O.Box 52050, Minneapolis, MN, 55402, US

(73) Assignee: Intel Corporation

(21) Appl. No.: 10/813,226

(22) Filed: Mar. 30, 2004

(51) Int. Cl. G06F 15/173

(52) U.S. Cl. 709/236; 709/238

(57) ABSTRACT

A scalable heterogeneous configurable circuit includes programmable elements and routers.

### FIELD

The present invention relates generally to reconfigurable circuits, and more specifically to reconfigurable circuits with programmable elements.

### BACKGROUND

Some integrated circuits are programmable or configurable. Examples include microprocessors and field programmable gate arrays. As programmable and configurable integrated circuits become more complex, the tasks of programming and configuring them also become more complex.

### BRIEF DESCRIPTION OF THE DRAWINGS

FIG. 1 shows a block diagram of a reconfigurable circuit;

FIG. 2 shows a diagram of multiple processing elements in a scalable architecture;

FIG. 3 shows four overlapping data sequences;

FIG. 4 shows a Fast Fourier Transform operation;

FIG. 5 shows a diagram of an electronic system in accordance with various embodiments of the present invention; and

FIGS. 6 and 7 show flowcharts in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

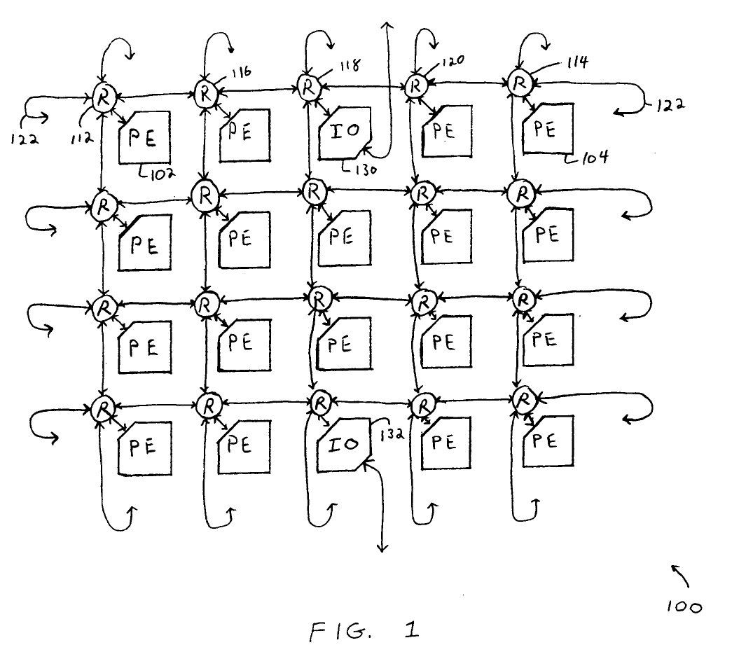

FIG. 1 shows a block diagram of a reconfigurable circuit. Reconfigurable circuit 100 includes a plurality of processing elements (PEs) and a plurality of interconnected routers (Rs). In some embodiments, each PE is coupled to a single router, and the routers are coupled together in toroidal arrangements. For example, as shown in FIG. 1, PE 102 is coupled to router 112, and PE 104 is coupled to router 114. Also for example, as shown in FIG. 1, routers 112 and 114 are coupled together through routers 116, 118, and 120, and are also coupled together directly by interconnect 122 (shown at left of R 112 and at right of R 114). The various routers (and PEs) in reconfigurable circuit 100 are arranged in rows and columns with nearest-neighbor interconnects, forming a toroidal interconnect. In some embodiments, each router is coupled to a single PE, and in other embodiments, each router is coupled to more than one PE.

In some embodiments of the present invention, configurable circuit 100 may have a “heterogeneous architecture” that includes various different types of PEs. For example, PE 102 may include a programmable logic array that may be configured to perform a particular logic function, while PE 104 may include a processor core that may be programmed with machine instructions. In some embodiments, some PEs may implement various types of “micro-coded accelerators” (MCAs). MCAs may be employed to accelerate particular functions, such as filtering data, performing digital signal processing (DSP) tasks, or convolutional encoding or decoding. In general, any number of PEs with a wide variety of architectures may be included within configurable circuit 100.

Configurable circuit 100, and programmable elements within configurable circuit 100, may have “scalable” architectures. For example, in various embodiments of the present invention, mechanisms are provided to enable multiple PEs to cooperate in supporting a function that a single processing element (PE) of a given complexity may not be able to perform (because of a combination of high processing requirements, high data rates, or other requirements). The scalable architecture allows larger “Super PEs” to be assembled when needed, and provides for a more finer grained programmable architecture when Super PEs are not needed. Scalability and Super PEs are discussed further below with reference to the remaining figures.

The interconnections between routers may be one or more of many types. For example, in some embodiments, routers (and PEs) may be coupled together by a “mesh” network that allows communications between routers in the mesh. Further, in some embodiments, routers may be coupled together by a dual mesh interconnect network. The dual mesh interconnect network may include two interconnect meshes, or “planes.” In some embodiments, one mesh may be utilized for data communications between PEs, and another mesh may be utilized for control communications between PEs. In other embodiments, one or both of the planes in the dual mesh interconnect network may be shared between control and data. For example, in some embodiments, control and data planes may be combined on the same mesh in part because the protocol by which data is communicated over the network may support in-band signaling. Alternatively, the control plane can be separated from the data plane, and serve as a dedicated Control and Configuration Mesh (CCM).

In some embodiments, the routers communicate with each other and with PEs using packets of information. For example, if PE 102 has information to be sent to PE 104, it may send a packet of data to router 112, which routes the packet to router 114 for delivery to PE 104. Packets may include control information or data, and may be of any size. In embodiments that utilize multiple interconnect planes, data packets may be routed between PEs using one plane, and control packets may be routed between PEs using a separate plane. In other embodiments, data packets and control packets may be routed between PEs on the same plane. In some embodiments, PEs are programmable in a manner that allows the dynamic allocation of the mesh between data and control. By programming or configuring a PE, the mesh may be allocated or re-allocated between data and control.

As shown in FIG. 1, configurable circuit 100 includes input/output (10) elements 130 and 132. Input/output elements 130 and 132 may be used by configurable circuit 100 to communicate with other circuits. For example, IO element 130 may be used to communicate with a host processor, and 10 element 132 may be used to communicate with an analog front end such as a radio frequency (RF) receiver or transmitter. Any number of IO elements may be included in configurable circuit 100, and their architectures may vary widely. Like PEs, IOs may be configurable or programmable, and may have differing levels of configurability based on their underlying architectures.

Configurable circuit 100 may be configured by receiving configuration packets through an 10 element. For example, 10 element 130 may receive configuration packets that include configuration information for various PEs and IOs, and the configuration packets may be routed to the appropriate elements. Configurable circuit 100 may also be configured by receiving configuration information through a dedicated programming interface. For example, a serial interface such as a serial scan chain may be utilized to program configurable circuit 100.

Configuration packets received by configurable circuit 100 may include configuration information to combine multiple scalable PEs to build a Super PE. For example, in some embodiments, configuration packets may include PE programming information to route data packets from a single data stream to multiple scalable PEs, and may also include PE programming information to cause the multiple scalable PEs to function in concert with one another.

In some embodiments, a PE or IO within configurable circuit 100 may serve as a processing element that receives configuration packets and configures various resources within integrated circuit 100. For example, 10 130 may include a processor that serves as a host interface node. The host interface node may receive configuration packets and forward the configuration packets to the appropriate routers and PEs for configuration.

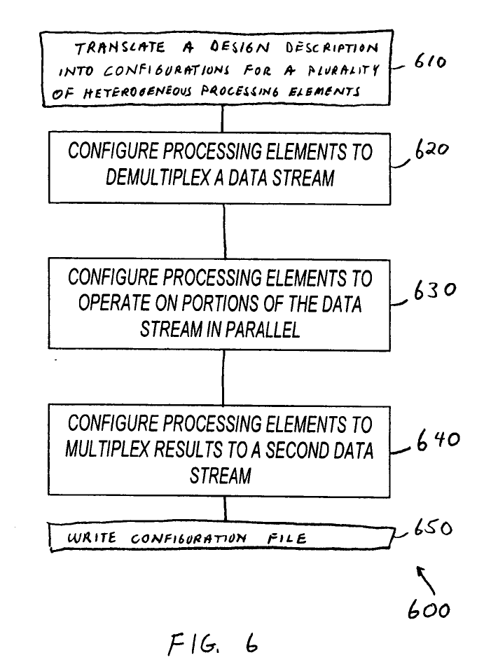

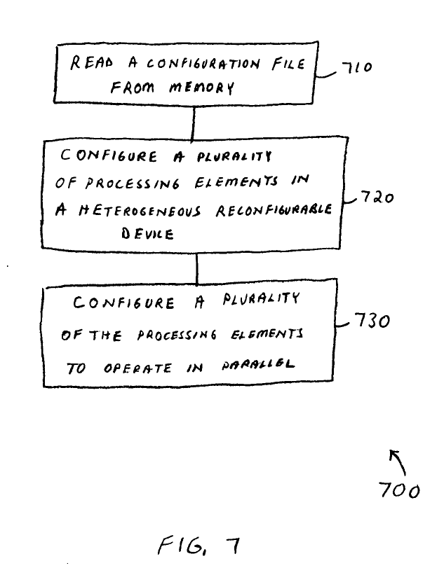

Various method embodiments of the present invention may be performed by a processing element within configurable circuit 100. For example, various methods described below with reference to FIGS. 6 and 7 may be performed by a processor within configurable circuit 100.

A Super PE may also be built when configurable circuit 100 is manufactured or prior to manufacturing. For example, a Super PE may be built out of multiple scalable PEs during the design process of configurable circuit 100 to reduce the design time and to reduce the design verification time. A Super PE built during the design of a configurable circuit may allow a high speed function to be implemented using PEs running in parallel at a lower clock rate. Any number of PEs may be combined at design time to form a Super PE.

Configurable circuit 100 may have many uses. For example, configurable circuit 100 may be configured to instantiate particular physical layer (PHY) implementations in communications systems, or to instantiate particular media access control layer (MAC) implementations in communications systems. For example, configurable circuit 100 may be configured to operate in compliance with a wireless network standard such as ANSI/IEEE Std. 802.11, 1999 Edition, although this is not a limitation of the present invention. As used herein, the term “802.11” refers to any past, present, or future IEEE 802.11 standard, including, but not limited to, the 1999 edition.

Various applications of configurable circuit 100 may benefit from a scalable architecture. For example, a high data rate function may be implemented in parallel with a lower clock rate than would otherwise be required. The high speed data path may be accommodated by a Super PE that includes multiple PEs operating in parallel, while the remainder of the design may be accommodated by smaller PEs operating at a relatively low clock rate. Viewed in this context, PEs can be seen as building blocks that may be assembled in a variety of different ways depending on the type of application. Demanding applications may build many Super PEs out of the building blocks, and less demanding applications may use the same building blocks in a different manner.

The scalable architecture of configurable circuit 100 also allows for larger or smaller integrated circuits to be fabricated without extensive redesign. For example, if a larger configurable circuit is desired to accommodate more complicated application, more scalable PEs may be instantiated rather than designing and verifying larger PEs. The scalable PEs can then be built into Super PEs to accommodate the more complicated applications. Reducing integrated circuit design and verification time for various instantiations of configurable circuit 100 may decrease time-to-market for high demand products.

In some embodiments, configurable circuit 100 is part of an integrated circuit. In some of these embodiments, configurable circuit 100 is included on an integrated circuit die that includes circuitry other than configurable circuit 100. For example, configurable circuit 100 may be included on an integrated circuit die with a processor, memory, or any other suitable circuit. In some embodiments, configurable circuit 100 coexists with radio frequency (RF) circuits on the same integrated circuit die to increase the level of integration of a communications device. Further, in some embodiments, configurable circuit 100 spans multiple integrated circuit die.

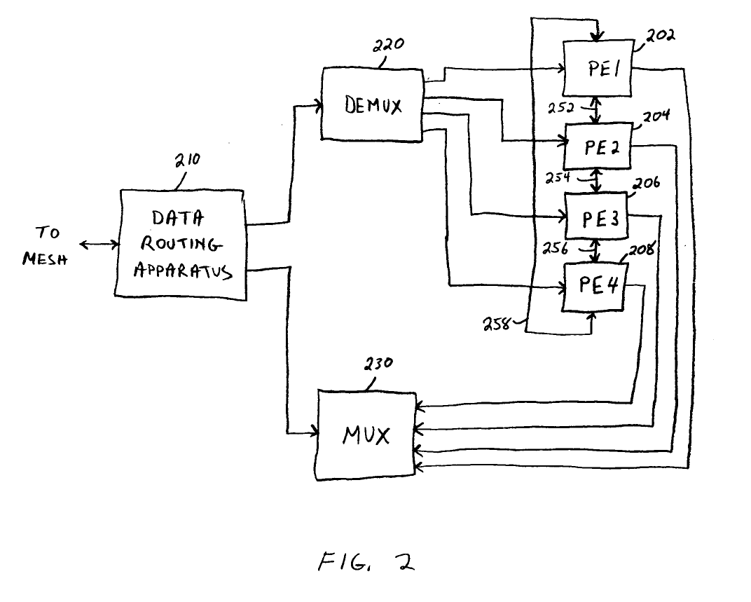

FIG. 2 shows a diagram of multiple processing elements in a scalable architecture. Processing elements 202, 204, 206, and 208, (also referred to as PE1, PE2, PE3, and PE4) are coupled together to operate as a Super PE. Data Router Adapter (DRA) 210 receives data from the mesh and sends it to demultiplexer (DEMUX) 220, which demultiplexes a single data stream into separate data streams, or “sub-streams.” Each separate data stream is sent to one PE. Each PE operates on one of the separate data streams, and produces an output data stream. Multiplexer (MUX) 230 remultiplexes (combines) the output data streams together and provides results from the Super PE to the mesh. Processing elements 202, 204, 206, and 208 may be of the same type or may be of differing types.

In some embodiments, the data rates into each PE may be less than the data rate into DEMUX 220. For example, if the data rate into DEMUX 220 is equal to “f,” the data rates into each PE may be f/4, or f divided by the number of parallel PEs in the Super PE.

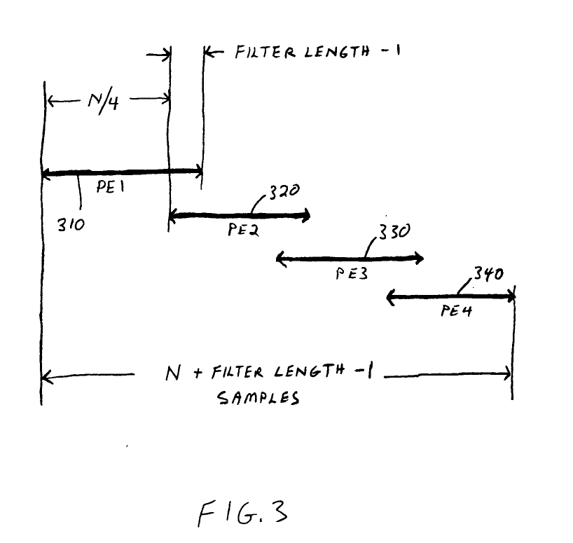

In some embodiments, the separate data streams may be mutually exclusive, and other embodiments, the separate data streams may not be mutually exclusive. For example, a data stream may be broken into non-overlapping segments that are mutually exclusive, where each non-overlapping segment is sent to one of PE1, PE2, PE3, or PE4. In other embodiments, a data stream may be broken into overlapping segments that are not mutually exclusive, and each overlapping segment is sent to one of PE1, PE2, PE3, or PE4. An example of overlapping data segments is described further below with reference to FIG. 3.

In some embodiments, PEs combined in a Super PE may communicate with each other. For example, as shown in FIG. 2, PE1 may communicate with PE2 using interconnect 252, PE2 may communicate with PE3 using interconnect 254, PE3 may communicate with PE4 using interconnect 256, and PE4 may communicate with PE1 using interconnect 258. The PEs are not limited to communicating with each other in the manner shown. For example, PE1 may also communicate with PE3, and PE2 may also communicate with PE4.

Interconnect 252, 254, 256, and 258 may be dedicated interconnect used within a group of scalable PEs, or may be the mesh interconnect in a configurable circuit. For example, the various PEs in the Super PE may communicate with each other by routing packets on the same packet-based interconnect used by PEs not in a Super PE.

Although four PEs are shown in a Super PE in FIG. 2, this is not a limitation of the present invention. For example, in some embodiments, more than four PEs are combined in a Super PE, and in other embodiments, less than four PEs are combined in a Super PE. The example of FIG. 2 shows PEs combined in parallel to form a Super PE, although this is not a limitation of the present invention. For example, in some embodiments, PEs may be combined in series, or in a series/parallel combination. Further, PEs may be combined before or after manufacture. PEs may be combined prior to manufacture by a designer, and may be combined subsequent to manufacture by programming the reconfigurable circuit to combine PEs into a Super PE.

The manner in which DRA 210, DEMUX 220, and MUX 230 are implemented is not a limitation of the present invention. For example, in some embodiments, a fifth PE may be configured to implement DRA 210, DEMUX 220, and MUX 230 and routers may route data packets between DEMUX 220, MUX 230, and PE1, PE2, PE3, and PE4. Also for example, routers within the configurable circuit may be configurable to implement DRA 210, DEMUX 220, and MUX 230. In still further embodiments, DRA 210, DEMUX 220, and MUX 230 may be distributed among PEs. For example, a PE that sources information on the mesh may be configured to directly demultiplex data packets among multiple PEs combined into a Super PE, and a destination PE may receive packets from the multiple PEs, effectively multiplexing them together upon reception. Further DRA 210, DEMUX 220, and MUX 230 may be implemented with dedicated hardware. For example, a Super PE may be created when the reconfigurable circuit is designed, and hardware may be dedicated in support of the Super PE.

In some embodiments, PE1, PE2, PE3, and PE4 may be micro-coded accelerator (MCA) PEs such as Filter MCAs (FMCAs) that are designed to accelerate filtering operations such as finite impulse response (FIR) filtering. In these embodiments, the architecture shown in FIG. 2 may be referred to as a “Super Filter MCA.” In other embodiments, PE1, PE2, PE3, and PE4 may be micro-coded accelerator (MCA) PEs such as Viterbi MCAs (VMCAs) that are designed to accelerate decoding operations such as Viterbi decoding of convolutionally encoded sequences. In these embodiments, the architecture shown in FIG. 2 may be referred to as a “Super Viterbi MCA.”

FIG. 3 shows four overlapping data sequences. Data sequences 310, 320, 330, and 340 are examples of data sequences that may result from the operation of DEMUX 220 (FIG. 2). In the example of FIG. 3, data sequence 310 is routed to PE1, data sequence 320 is routed to PE2, data sequence 330 is routed to PE3, and data sequence 340 is routed to PE4.

The data sequences of FIG. 3 show how a data stream may be de-multiplexed for an FIR filter operation on a block size of N. Each data sequence includes N/4 samples plus some overlap, shown as one less than the filter length. The amount of overlap in the data sequences may depend in part on the window length. In embodiments represented by FIG. 3, the data sequences are not mutually exclusive.

Embodiments that utilize the data streams as represented by FIG. 3 may operate without any inter-PE communication. For example, referring back to FIG. 2, PE1, PE2, PE3, and PE4 may receive the data sequences 310, 320, 330, and 340, respectively, and may provide an FIR operation without necessarily having any interprocessor communications on nodes 252, 254, 256, and 258. By providing overlap between the various data sequences in FIG. 3, each PE has all the information necessary to perform its respective portion of the filter operation.

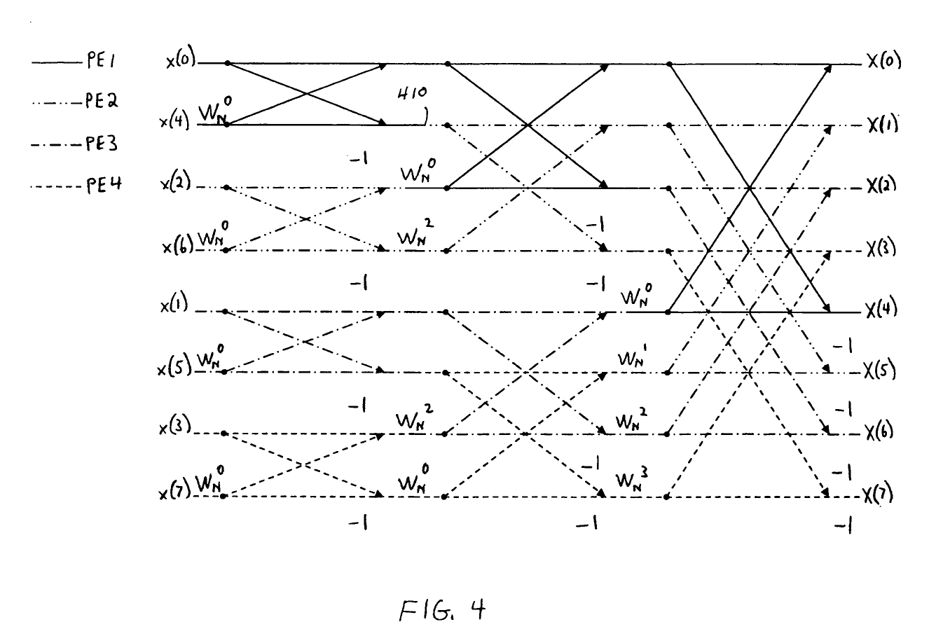

FIG. 4 shows a Fast Fourier Transform (FFT) operation. The example of FIG. 4 represents a decimation-in-time radix-2 FFT implementation. The FFT operation of FIG. 4 may be performed by a Super PE such as the one shown in FIG. 2. The dashed lines in FIG. 4 show an example data-flow of how an 8-point FFT would be mapped to four PEs in a Super PE such as that shown in FIG. 2. For the initial FFT stage, the data are demultiplexed between PE inputs and each PE may independently perform a butterfly operation. In subsequent stages, data is transferred between the various PEs in the Super PE to accommodate the remaining butterfly operations. For example, at 410, data output from the first FFT stage is transferred from PE1 to PE2. The remaining inter-PE communication is shown by the legend of dashed lines in FIG. 4. The inter-PE communication shown in FIG. 4 is not meant to be a limitation of the present invention. An FFT operation may be implemented in many different ways, and the inter-PE communication within the Super PE may be modified as necessary depending on the FFT implementation.

The various embodiments of the present invention are not limited to Super PEs that implement filters or FFTs. For example, a configurable circuit may implement an 802.11 PHY layer, and Super PEs may be used for many different functions within the PHY layer. Further, a configurable circuit may implement a video or graphics function, and Super PEs may be used for many different functions within the video or graphics function. Accordingly, the various embodiments of the invention are not limited to the examples given.

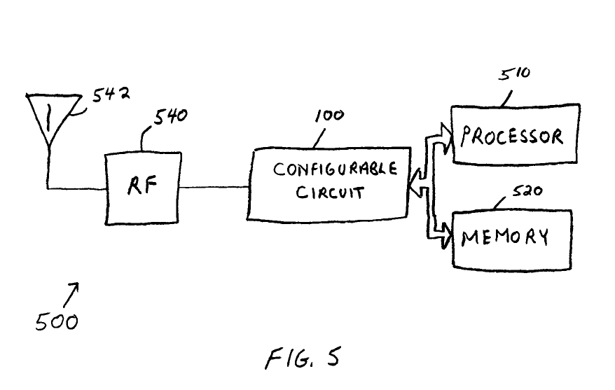

FIG. 5 shows a block diagram of an electronic system. System 500 includes processor 510, memory 520, configurable circuit 100, RF interface 540, and antenna 542. In some embodiments, system 500 may be a computer system to develop configurations for use in configurable circuit 100. For example, system 500 may be a personal computer, a workstation, a dedicated development station, or any other computing device capable of creating a configuration for configurable circuit 100. In other embodiments, system 500 may be an “end-use” system that utilizes configurable circuit 100 after it has been programmed to implement a particular configuration. Further, in some embodiments, system 500 may be a system capable of developing configurations as well as using them.

In some embodiments, processor 510 may be a processor that can perform methods described below with reference to FIGS. 6 and 7. For example, processor 510 may perform methods that transform design descriptions into configurations for configurable circuit 100, and processor 510 may also perform methods to configure configurable circuit 100. Configurations for configurable circuit 100 may be stored in memory 520, and processor 510 may read the configurations from memory 520 when configuring configurable circuit 100. Further, when transforming design descriptions into configurations for configurable circuit 100, processor 510 may store one or more configurations in memory 520. Processor 510 represents any type of processor, including but not limited to, a microprocessor, a microcontroller, a digital signal processor, a personal computer, a workstation, or the like.

In some embodiments, system 500 may be a communications system, and processor 510 may be a computing device that performs various tasks within the communications system. For example, system 500 may be a system that provides wireless networking capabilities to a computer. In these embodiments, processor 510 may implement all or a portion of a device driver, or may implement a lower level MAC. Also in these embodiments, configurable circuit 100 may implement one or more protocols for wireless network connectivity. In some embodiments, configurable circuit 100 may implement multiple protocols simultaneously, and in other embodiments, processor 510 may change the protocol in use by reconfiguring configurable circuit 100.

Memory 520 represents an article that includes a machine readable medium. For example, memory 520 represents any one or more of the following: a hard disk, a floppy disk, random access memory (RAM), dynamic random access memory (DRAM), static random access memory (SRAM), read only memory (ROM), flash memory, CDROM, or any other type of article that includes a medium readable by a machine such as processor 510. In some embodiments, memory 520 can store instructions for performing the execution of the various method embodiments of the present invention.

In operation of some embodiments, processor 510 reads instructions and data from memory 520 and performs actions in response thereto. For example, various method embodiments of the present invention may be performed by processor 510 while reading instructions from memory 520.

Antenna 542 may be either a directional antenna or an omni-directional antenna. For example, in some embodiments, antenna 542 may be an omni-directional antenna such as a dipole antenna, or a quarter-wave antenna. Also for example, in some embodiments, antenna 542 may be a directional antenna such as a parabolic dish antenna or a Yagi antenna. In some embodiments, antenna 542 is omitted.

Radio frequency (RF) interface 540 receives RF signals from antenna 542 and in various embodiments, performs varying amounts and types of signal processing. For example, in some embodiments, RF interface 540 may include amplifiers, oscillators, mixers, filters, demodulators, detectors, decoders, or the like. Also for example, RF interface 540 may perform signal processing such as frequency conversion, carrier recovery, symbol demodulation, or any other suitable signal processing. Further, RF interface 540 may be a bidirectional interface capable of transmitting and receiving signals.

In some embodiments, RF signals transmitted or received by antenna 542 may correspond to voice signals, data signals, or any combination thereof. For example, in some embodiments, configurable circuit 100 may implement a protocol for a wireless local area network interface, cellular phone interface, global positioning system (GPS) interface, or the like. In these various embodiments, RF interface 540 may operate at the appropriate frequency for the protocol implemented by configurable circuit 100. In some embodiments, RF interface 540 is omitted.

FIG. 6 shows a flowchart in accordance with various embodiments of the present invention. In some embodiments, method 600, or portions thereof, is performed by an electronic system, or an electronic system in conjunction with a person's actions. In other embodiments, all or a portion of method 600 is performed by a control circuit or processor, embodiments of which are shown in the various figures. Method 600 is not limited by the particular type of apparatus, software element, or person performing the method. The various actions in method 600 may be performed in the order presented, or may be performed in a different order. Further, in some embodiments, some actions listed in FIG. 6 are omitted from method 600.

Method 600 is shown beginning with block 610 where a design description is translated into configurations for a plurality of heterogeneous processing elements (PEs). For example, a design description representing a final configuration for a configurable circuit such as configurable circuit 100 (FIG. 1) may be translated into configurations for PEs such as those shown in FIGS. 1 and 2. In some embodiments, translating a design description may include many operations. For example, a design description may be in a high level language, and translating the design description may include partitioning, parsing, grouping, placement, and the like. In other embodiments, translating a design description may include few operations. For example, a design description may be represented using an intermediate representation, and translating the design description may include generating code for the various PEs.

In some embodiments, a configuration specified by the design description in block 610 may be in the form of an algorithm that a particular PHY, MAC, or combination thereof, is to implement. The algorithm may be in the form of a procedural or object-oriented language, such as C or C++, or hardware design language (HDL), or may be written in a specialized, or “stylized” version of a high level language.

In some embodiments, constraints may be specified to guide the translation of a design description. Constraints may include minimum requirements that the completed configuration should meet, such as latency and throughput constraints. In some embodiments, various constraints are assigned weights so that they are given various amounts of deference during the translation of the design description. In some embodiments, constraints may be listed as requirements or preferences, and in some embodiments, constraints may be listed as ranges of parameter values. In some embodiments, constraints may not be absolute. For example, if the target reconfigurable circuit includes a data path that communicates with packets, the measured latency through part of the design may not be a fixed value but instead may be one with a statistical variation.

At 620, one or more processing elements are configured to demultiplex a data stream; at 630, one or more processing elements are configured to operate on portions of the data stream in parallel; and at 640, one or more processing elements are configured to multiplex results to a second data stream. The actions of 620, 630, and 640 may correspond to the operation of a Super PE such as that described with reference to FIG. 2. As described above, a Super PE may be generated by configuring a circuit having a scalable architecture to allow multiple PEs to operate in parallel. In this context, “configuring” refers to the process of developing the configuration information that will determine the behavior of a configurable circuit when programmed.

Method 600 may measure a “quality” of the configuration, and repeat all or portions of the actions listed in blocks 610, 620, 630, or 640. For example, the quality of the current configuration may be measured by a “profiler” implemented in hardware or software. In some embodiments, a profiler may allow the gathering of information that may be compared against constraints to determine the quality of the current configuration. For example, a profiler may be utilized to determine whether latency or throughput requirements can be met by the current configuration. If constraints are not met, or if the margin by which they are met is undesirable, portions of blocks 610, 620, 630, or 640 may be repeated. For example, a design may be placed or routed differently, or PEs may be allocated to Super PEs differently, or any combination of changes may be made to the configuration. Evaluation may include evaluating a cost function that takes into account many possible parameters, including constraints.

A completed configuration is output from 640 when the constraints are met. In some embodiments, the completed configuration is in the form of a file that specifies the configuration of a configurable circuit such as configurable circuit 100 (FIG. 1). In some embodiments, the completed configuration is in the form of configuration packets to be loaded into a configurable circuit such as configurable circuit 100. The form taken by the completed configuration is not a limitation of the present invention.

At 650 of method 600, a configuration file is written. In some embodiments, the file may include configuration information for PEs, including information governing the generation of Super PEs. If more than one design description is to be translated, then method 600 may be repeated for each design description. At the completion of method 600, one or more configuration files exist, where each configuration file specifies a configuration for a configurable circuit.

FIG. 7 shows a flowchart in accordance with various embodiments of the present invention. In some embodiments, method 700, or portions thereof, is performed by an electronic system, a control circuit, a processor, a configurable circuit, or a processing element (PE), embodiments of which are shown in the various figures. Method 700 is not limited by the particular type of apparatus or software element performing the method. The various actions in method 700 may be performed in the order presented, or may be performed in a different order. Further, in some embodiments, some actions listed in FIG. 7 are omitted from method 700.

Method 700 is shown beginning with block 710 where a configuration file is read from memory. A configuration file may be read by a processor in an electronic system, or may be read by an element within a configurable circuit. For example, a processor such as processor 510 (FIG. 5) may read a configuration file, or a processing element or input/output element such as 10 130 (FIG. 1) may read a configuration file. The memory may be memory within an electronic system such as system 500 (FIG. 5), or may be memory dedicated within a configurable circuit.

At 720, a plurality of processing elements in a heterogeneous reconfigurable device are configured. In some embodiments, this corresponds to a processor in an electronic system sending configuration packets to a configurable circuit such as configurable circuit 100 (FIG. 1). In other embodiments, this corresponds to an element within a configurable circuit receiving configuration information and distributing it to appropriate processing elements.

In some embodiments, only a portion of a heterogeneous reconfigurable device is configured at 720. For example, a reconfigurable device may implement multiple wireless network protocols simultaneously, and less than all of the multiple protocols may be changed while others remain.

At 730, a plurality of the processing elements are configured to operate in parallel. In some embodiments, the actions of 730 correspond to configuring a Super PE such as that described with reference to FIG. 2. A Super PE may be used for any processing purpose. For example, in some embodiments, a Super PE may be configured to perform filtering, such as with an FIR. Also for example, in other embodiments, a Super PE may be configured to perform an FFT. Also for example, in still further embodiments, a Super PE may be configured to perform convolutional coding or decoding.

As used in FIG. 7, “configuring” refers to sending configuration information to PEs to affect their behavior. For example, if a configuration file includes information for configuring one or more Super PEs, various processing elements may be configured in a manner that provides multiple PEs to be utilized in parallel.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

1. A method comprising configuring a plurality of processing elements within a heterogeneous configurable circuit to demultiplex a data stream, operate on portions of the data stream in parallel, and multiplex results to a second data stream.

2. The method of claim 1 wherein configuring a plurality of processing elements comprises configuring a plurality of processing elements capable of filtering data.

3. The method of claim 2 wherein configuring a plurality of processing elements further comprises configuring at least one programmable element to demultiplex the data stream into non-overlapping segments.

4. The method of claim 3 wherein the non-overlapping segments comprise data packets.

5. The method of claim 4 wherein configuring at least one programmable element comprises configuring the at least one programmable element to route data packets to a plurality of processing elements capable of filtering data.

6. The method of claim 1 wherein configuring a plurality of processing elements further comprises configuring at least one programmable element to demultiplex the data stream into overlapping segments.

7. The method of claim 6 wherein the overlapping segments comprise data packets.

8. The method of claim 7 wherein configuring at least one programmable element comprises configuring the at least one programmable element to route data packets to a plurality of processing elements capable of filtering data.

9. A method comprising configuring a heterogeneous configurable device to:
demultiplex a packet-based input data stream into a plurality of separate data streams;
route the plurality of separate data streams to processing elements in parallel; and
multiplex output packets from processing elements in parallel to produce a packet-based output data stream.

10. The method of claim 9 wherein configuring the heterogeneous configurable device to demultiplex a packet-based input stream comprises configuring a programmable element that is coupled to routers in a row and column arrangement.

11. The method of claim 9 wherein configuring the heterogeneous configurable device to route the plurality of separate data streams comprises configuring a programmable element that is coupled to routers in a row and column arrangement.

12. The method of claim 9 wherein configuring the heterogeneous configurable device to multiplex output packets from processing elements in parallel comprises configuring a programmable element that is coupled to routers in a row and column arrangement.

13. The method of claim 9 wherein configuring the heterogeneous configurable device to route the plurality of separate data streams comprises configuring a programmable element to route the separate data streams to a plurality of processing elements capable of filtering data.

14. The method of claim 13 wherein filtering data comprises performing a Fast Fourier Transform.

15. The method of claim 13 wherein filtering data comprises performing a finite impulse response filter.

16. The method of claim 9 wherein configuring the heterogeneous configurable device to route the plurality of separate data streams comprises configuring a programmable element to route the separate data streams to a plurality of processing elements capable of implementing a Viterbi decoder.

17. An apparatus including a medium to hold machine-accessible instructions that when accessed result in a machine performing:
configuring a plurality of processing elements within a heterogeneous configurable circuit to demultiplex a data stream, operate on portions of the data stream in parallel, and multiplex results to a second data stream.

18. The apparatus of claim 17 wherein configuring a plurality of processing elements comprises configuring a plurality of processing elements capable of filtering data.

19. The apparatus of claim 18 wherein configuring a plurality of processing elements further comprises configuring at least one router to route data packets within the integrated circuit.

20. An apparatus comprising:
a heterogeneous plurality of configurable processing elements; and
a plurality of interconnected routers to route packets between the plurality of configurable processing elements;
wherein a subset of the plurality of configurable processing elements are configurable to be operated in parallel.

21. The apparatus of claim 20 wherein the plurality of interconnected routers are configurable to demultiplex a data stream to produce a plurality of sub-streams.

22. The apparatus of claim 21 wherein the plurality of interconnected routers are further configurable to route the plurality of sub-streams to the subset of the plurality of configurable processing elements.

23. The apparatus of claim 20 wherein at least one of the plurality of configurable processing elements is configurable to demultiplex a data stream to produce a plurality of sub-streams.

24. The apparatus of claim 23 wherein the at least one of the plurality of configurable processing elements are further configurable to route the plurality of sub-streams to the subset of the plurality of configurable processing elements.

25. The apparatus of claim 20 wherein the subset of the plurality of configurable processing elements comprises micro-coded processing elements.

26. The apparatus of claim 25 wherein the micro-coded processing elements comprise filter micro-coded accelerators.

27. An electronic system comprising:
an antenna;
a radio frequency circuit to receive communications signals from the antenna; and
a configurable circuit coupled to the radio frequency circuit, the configurable circuit including a heterogeneous plurality of configurable processing elements, and a plurality of interconnected routers to route packets between the plurality of configurable processing elements, wherein a subset of the plurality of configurable processing elements are configurable to be operated in parallel.

28. The electronic system of claim 27 wherein at least one of the plurality of configurable processing elements are configurable to demultiplex a data stream to produce a plurality of sub-streams.

29. The electronic system of claim 27 wherein the subset of the plurality of configurable processing elements are configurable to perform a Fast Fourier Transform.

30. The electronic system of claim 27 wherein the subset of the plurality of configurable processing elements are configurable to perform a finite impulse response filter.
